(19) United States
(12) Patent Application Publication
(10) Pub. No.: US 2026/0037416 A1
(43) Pub. Date: Feb. 5, 2026

(54) AUTOMATED AND QUANTITATIVE QUALITY ASSESSMENT OF TEST AUTOMATE GENERATION TOOLS

(71) Applicant: SAP SE, Walldorf (DE)

(72) Inventor: Philipp Obreiter, St. Leon-Rot (DE)

(73) Assignee: SAP SE, Walldorf (DE)

(21) Appl. No.: 18/793,490

(22) Filed: Aug. 2, 2024

(51) Int. Cl. G06F 11/36

(52) U.S. Cl. CPC G06F 11/3692; G06F 11/362

(57) ABSTRACT

Quantitative quality assessments of a test automate generation tool can be performed automatically via an adapted mutation strategy. The test automate generation tool is employed to generate a corresponding test automate for each software artifact of a set of software artifacts. A domain expert manually creates mutated versions of the software artifacts. A set of mutant test automates is created programmatically for each test automate, where each mutant test automate in a given set corresponds to a given mutated version of the corresponding software artifact and is created by replacing references to the software artifact in the code of the test automate with references to the given one of the mutated versions of the software artifact. The test automates and mutant test automates are executed to obtain pass or fail test results, which are aggregated and output as a quantitative quality measure of the test automate generation tool.

### FIELD

The field generally relates to assessing the performance of tools that use generative artificial intelligence (AI) to create test automates for testing software artifacts.

### BACKGROUND

Software vendors rely heavily on automated testing. Towards this end, test automates can be executed to perform testing of software artifacts in various scenarios such as integration testing, system testing, regression testing, and end-to-end testing before a software release or update. Increasingly, generative AI tools are used to automate the creation of test automates. However, it can be difficult to assess and monitor the output of such tools in an efficient and repeatable manner.

Typically, human experts are tasked with manually assessing test automates created by generative AI tools. For example, an expert can manually assess the quality of a given test automate and provide qualitative feedback. However, manual review of test automates by experts is time-consuming, costly, and provides inconsistent results.

### BRIEF DESCRIPTION OF THE DRAWINGS

FIG. 1 is a block diagram of an example system implementing quantitative quality assessment of test automate generation tools.

FIG. 2 is a block diagram of a detail view of certain aspects of the example system of FIG. 1.

FIG. 3 is a flowchart of an example method of performing quantitative quality assessment of a test automate generation tool.

FIG. 4 is a flowchart of an example method of creating a mutant test automate.

FIG. 5 is a block diagram of an example software artifact and a mutant version of the example software artifact.

FIG. 6 is a block diagram of another example software artifact and a mutant version of the example software artifact.

FIG. 7 is a block diagram of a modified version of the example system of FIG. 1 for a test-driven development use case.

FIG. 8 is a flowchart of an example method of performing quantitative quality assessment of a test code completion tool.

FIG. 9 is a block diagram of an example computing system in which described embodiments can be implemented.

FIG. 10 is a block diagram of an example cloud computing environment that can be used in conjunction with the technologies described herein.

### DETAILED DESCRIPTION

### Example 1

### Overview

Test automates are employed at design-time during different stages of software development, as well as run-time in a production environment. For example, during development, test automates may be executed for code changes released as part of a code pipeline. As another example, test automates may be executed at regular intervals to ensure functionality of a given software product is regression-free and that integrating functions works in unison. Such tests include, for example, unit tests, daily tests, process tests, qualification tests, customer testing for their specific implementations and configuration, content tests, and end-to-end integration tests.

Originally, test automates were created manually by software engineers and evaluating using heuristics such as Statement Coverage and Branch Coverage. In the context of manually-created test automates, these heuristics typically provide enough insight for the software engineer to decide whether the tests have attained a desired level. These heuristics may be sufficient in the context of manually-created test automates, since there is already a “human in the loop” who created the test automates.

Generative AI tools are often used to automate the creation of test automates. However, existing methods for evaluating the output of such tools are inefficient and fail to provide quantitative results. Typically, human experts are tasked with manually assessing test automates created by generative AI tools. However, there are several drawbacks associated with manual assessment of test automate generation tool output by human experts. For example, manual assessment by human experts produces qualitative rather than quantitative results which lack repeatability. Further, manual assessment by human experts is costly, due to relatively high opportunity costs for human experts and the amount of time required to perform such evaluations. Still further, manual assessment by human experts does not provide instant feedback (e.g., it may take a week to receive an assessment from a human expert).

Techniques are described herein for performing a quantitative quality assessment of a test automate generation tool in an automated manner. The disclosed techniques employ mutation testing techniques in a different way and at a different stage of the testing process. In particular, for a given set of software artifacts for a particular domain, a human domain expert manually creates sets of mutated versions of the software artifacts (i.e., one set of mutated versions for each software artifact in the set). Once the mutated versions have been created, the remainder of the test automate assessment process is automated and does not require human intervention. Accordingly, there is a one-time setup cost associated with obtaining the manually-created mutated versions of the software artifacts, but minimal ongoing costs as the remainder of the process is fully automated.

In accordance with disclosed techniques, a set of software artifacts is received, along with a plurality of mutated versions of each software artifact that were manually generated by a domain expert (e.g., a software engineer with expertise in the domain associated with the set of software artifacts). A test automate generation tool which employs generative AI can then be employed to generate a test automate for each of the software artifacts in the set, such that a given one of the test automates is associated with a given one of the software artifacts and includes code with references to the given software artifact.

Subsequently, a set of mutant test automates is created for each test automate (and thus, for each software artifact). Each mutant test automate is created by modifying the corresponding test automate to include references to one of the mutated versions of the software artifact associated with that test automate. In particular, the code of the test automate is modified by replacing references to the software artifact with references to one of the mutated versions of the software artifact, and the mutant test automate is populated with the modified code.

The original test automates and the mutant test automates are then executed to obtain respective test results (i.e., an indication of whether the test automate/mutant test automate passed or failed the test). The test results can then be aggregated to obtain a quantitative quality measure of the test automate generation tool. Aggregating the test results can include, for example, determining a total number of original test automates, determining a total number of mutant test automates, determining a number of the original test automates that passed; determining a number of the mutant test automates that passed; determining a number of the original test automates that failed; determining a number of the mutant test automates that failed; determining a percentage of the original test automates that passed; and/or determining a percentage of the mutant test automates that failed. For example, a sensitivity metric can be determined based on the number of mutant test automates that failed and the total number of the mutant test automates, whereas a specificity metric can be determined based on the number of original test automates that passed and a total number of the original test automates. In particular, a test automate with an acceptable level of performance should act as a binary classifier for detecting mutant software artifacts (i.e., a first class), while not falsely reporting original software artifacts (i.e., a second class).

The quantitative quality measure of the test automate generation tool can be output and compared to previous quantitative quality measures, or to a threshold, to determine whether the performance of the test automate generation tool is acceptable. For example, the quantitative quality measure of the test automate generation tool can be compared to a previous quantitative quality measure of the test automate generation tool. A determination can be made based on the comparison as to whether the quantitative quality measure of the test automate generation tool is less than the previous quantitative quality measure of the test automate generation tool. If so, an indication of a quality regression of the test automate generation tool can be output. Such an indication can trigger actions such as waiting to release a version of the test automate generation tool that is being tested and instead continuing to use a prior version of the test automate generation tool (e.g., until the version that is being tested has been modified and has demonstrated an acceptable quality level in a subsequent assessment).

The described technologies thus offer considerable improvements over conventional techniques for assessing the performance of test automate generation tools.

In addition, techniques are described herein for automated and quantitative assessment of the quality of output of a test code completion tool. The test code completion tool can be used in the context of test-driven development, where tests are to be generated before the productive code. In particular, the test code completion tool can generate predicted code to complete test code within software artifacts and mutated versions of the software artifacts. The results of execution of the completed test code of the software artifacts and mutated versions can be assessed to evaluate the performance of the test code completion tool.

### Example 2

### Example Test Automate

A test automate may be implemented as a software object that includes an automation script. The automation script may be written in a programming language such as Selenium, Tricentis Tosca™, Katalon™, Cypress, or the like. Accordingly, a software object referred to as a test automate can contain computer-readable instructions which, when executed, perform an automated test (e.g., a test which does not require or involve any user interaction). The software object can be an Extensible Markup Language (XML) object, a JavaScript Object Notation (JSON) object, a .Java file, or another type of software object.

As another example, a test automate can be implemented as an object within a framework that supports a keyword-driven approach. In such frameworks, keywords are used to dictate the actions of the test automate, thereby simplifying the process of scripting tests. In either case, a test automate refers to a software object which can be executed on demand in an automated manner, without requiring any user interaction for its functionality.

In some examples, in addition to test automates provided by a software platform, a customer of the software platform may have the capability to use their own automation tools to generate their own test automates. For example, the customer may use automation tools to generate customer-supplied test automates.

### Example 3

### Example System Implementing Assessment of Test Automate Generation Tools

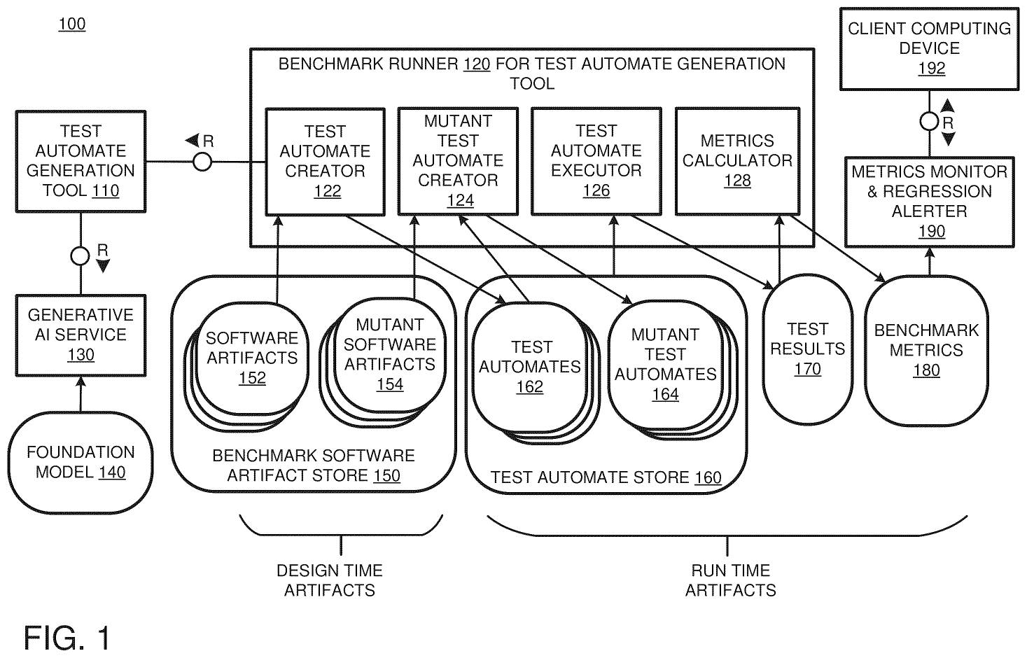

FIG. 1 is a block diagram of an example system 100 implementing quantitative assessment of test automate generation tools. In the example, the system 100 includes a test automate generation tool 110 and a benchmark runner 120 for the test automate generation tool 110. The test automate generation tool 110 employs a generative AI service 130, which in turn employs a foundation model 140. A benchmark software artifact store 150 stores software artifacts 152 and mutant software artifacts 154 which serve as inputs to the benchmark runner 120 and can be considered as design time artifacts. A test automate store 160 stores test automates 162 and mutant software artifact test automates 164. Test results 170 and benchmark metrics 180 are output by the benchmark runner 120. The test automates 162, mutant test automates 164, test results 170, and benchmark metrics 180 can considered as run time artifacts. As shown, the benchmark metrics 180 can be output to a metrics monitor and regression alerter 190, which in turn can output alerts and other data to a client computing device 192.

The benchmark runner 120 can include software designed to execute benchmark tests to obtain a quantitative quality measure of the output of the test automate generation tool 110. Towards this end, the benchmark runner 120 includes a test automate creator 122, mutant test automate creator 124, test automate executor 126, and metrics calculator 128, which can be implemented as individual software modules. The test automate creator 122 receives software artifacts 152 as inputs; software artifacts 152 are alternatively referred to herein as original software artifacts (e.g., software artifacts which do not contain any mutations and for which test automates are to be generated by the test automate generation tool 110). To obtain a test automate for a given one of the software artifacts 152, the test automate creator 122 sends a request to an Application Programming Interface (API) of the test automate generation tool. The request can include the software artifact, among other data. In some examples, the API of the test automate generation tool 110 is a web service endpoint, and the test automate creator 122 sends the request to a URL of the web service endpoint to call the API of the test automate generation tool 110.

The test automate generation tool 110 can be configured to utilize the generative AI service 130 to autonomously generate test automates based on the software artifacts 152. The generative AI service 130 can incorporate the foundation model 140, which can be a large language model (LLM) or another type of machine learning model. An LLM can take the form of an AI or machine learning model that is designed to understand and generate human language. Such models typically leverage deep learning techniques such as transformer-based architectures to process language with a very large number (e.g., billions) of parameters. Examples include the Generative Pre-trained Transformer (GPT) developed by OpenAI (e.g., ChatGPT), Bidirectional Encoder Representations from Transforms (BERT) by Google, A Robustly Optimized BERT Pretraining Approach developed by Facebook AI, Megatron-LM of NVIDIA, or the like. Pretrained models are available from a variety of sources. Additionally or alternatively, the foundation model can include a machine learning model that is designed to understand the language of the software artifacts 152 (e.g., a programming language such as Advanced Business Application Programming (ABAP) or a data modeling language such as is used in conjunction with Core Data Services (CDS) technology of SAP SE, of Walldorf, Germany). An example of such a model is the StarCoder model developed by BigCode.

After generating a test automate, the test automate generation tool 110 returns the test automate to the test automate creator 122 via the API. The test automate creator 122 then stores the test automate in the test automate store 160 as a test automate 162. Test automates for multiple software artifacts 152 (e.g., a set of software artifacts for testing a particular domain) can be generated and stored in this manner.

As shown, the test automates 162 serve as inputs to the mutant test automate creator 124, along with mutant software artifacts 154 (e.g., mutated versions of the software artifacts 152). As described herein, the mutant software artifacts 154 can be created by domain experts (e.g., software engineers with expertise regarding the type of software artifacts which will serve as the basis for the mutated versions). The mutant test automate creator 124 then creates mutant software artifact test automates 164 which are also referred to as mutant test automates herein for the sake of brevity. In particular, the mutant test automate creator 124 can create a mutant test automate for one of the mutant software artifacts 154 by taking the code of a corresponding one of the test automates 162 and replacing references to the corresponding one of the software artifacts 152 therein with references to said one of the mutant software artifacts 154. A mutant test automate 164 can then be populated with this modified code. A plurality of mutant test automates 164 can be created by the mutant test automate creator 124 in this manner. For example, a corresponding set of mutant test automates 164 can be created for each of the software artifacts 152.

The test automate executor 126 is operable to execute (e.g., run) the test automates and mutant test automates. When each test automate or mutant test automate is run by the test automate executor 126, corresponding test results 170 are generated which indicate whether the test automate or mutant test automate passed or failed. The test results 170 (i.e., a pass or fail indication for each test automate and mutant test automate) are then input to the metrics calculator 128 of the benchmark runner 120, which can be configured to produce the benchmark metrics 180. As described further herein, the benchmark metrics 180 can include metrics such as a sensitivity metric, a specificity metric, a balanced accuracy metric, a harmonic mean of sensitivity and specificity metric, a Matthews Correlation Coefficient, an F₁ score metric, and the like, or combinations of such metrics. The benchmark metrics 180 can serve as quantitative quality measures of the test automate generation tool 110.

The benchmark metrics 180 are output to the metrics monitor and regression alerter 190, which can be configured to monitor the benchmark metrics 180 and generate and output alerts when the benchmark metrics 180 indicate that the quality of the test automates generated by the test automate generation tool 110 has regressed. In particular, a regression alert can be output by the metrics monitor and regression alerter 190 when the quantitative quality measure of the test automate generation tool 110 has decreased (e.g., relative to a previous quantitative quality measure, or below a predefined threshold). As shown, outputs of the metrics monitor and regression alerter 190, such as regression alerts, can be output to a client computing device 192 (e.g., for display to a user). In some examples, the client computing device 192 can request data from the metrics monitor and regression alerter, such as values of particular metrics, in addition to receiving alerts generated by the metrics monitor and regression alerter 190.

Any of the systems herein, including the system 100, can comprise at least one hardware processor and at least one memory coupled to the at least one hardware processor.

The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity, with additional functionality, more complex components, and the like. For example, numerous mutant software artifacts 154 (and a corresponding number of mutant test automates 164) may be created for each of the software artifacts 152. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the foundation model 140, the software artifacts 152, the mutant software artifacts 154, the test automates 162, the mutant test automates 164, the test results 170, the benchmark metrics 180, and the like can be stored in one or more computer-readable storage media or computer-readable storage devices. The technologies described herein can be generic to the specifics of operating systems or hardware and can be applied in any variety of environments to take advantage of the described features.

### Example 4

### Detail View of System Implementing Assessment of Test Automate Generation Tools

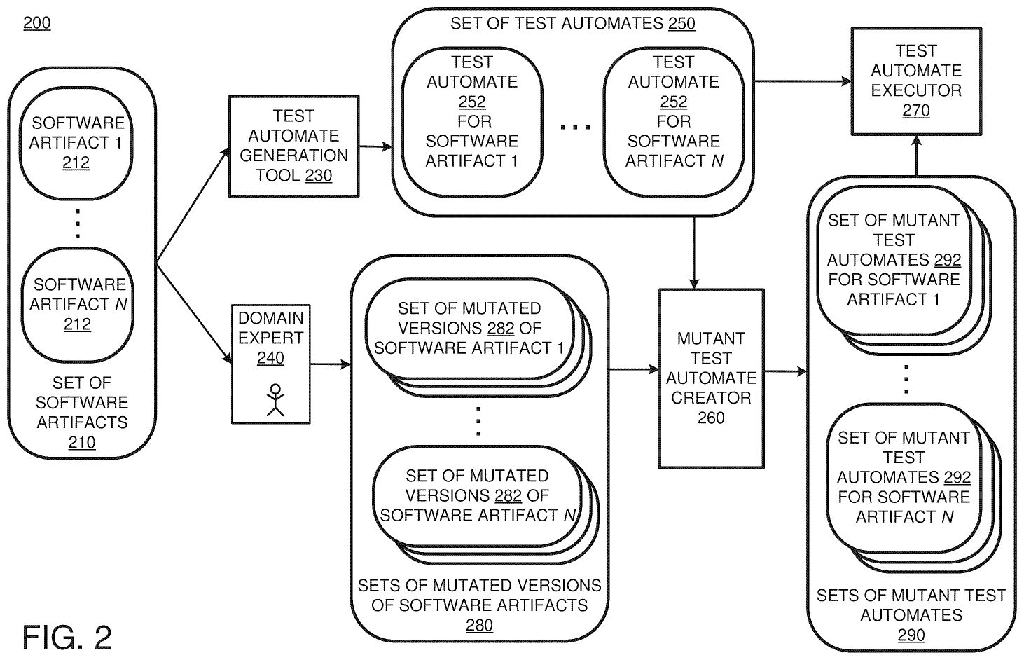

FIG. 2 is a block diagram of a detail view 200 of certain aspects of the example system 100 of FIG. 1. Detail view 200 is provided to further illustrate the relationships between the various artifacts and test automates, and the relative quantities of each.

In the example, a set of software artifacts 210 includes software artifacts 1 . . . N 212, which correspond to software artifacts 152 of FIG. 1. The software artifacts 1 . . . N 212 may be selected (e.g., by a software or test engineer or a domain expert) as a comprehensive representation of the types of software artifacts associated with a particular domain to be tested. As shown, the set of software artifacts 210 are provided to the test automate generation tool 230, which corresponds to test automate generation tool 110 of FIG. 1, as well as to a domain expert 240 (e.g., a person with expertise in the domain to be tested).

The number N of software artifacts in the set of software artifacts 210 may vary depending on the software artifact type. For example, for software artifacts such as virtual data model objects (e.g., CDS views) or Structured Query Language (SQL) views, the number of language features to be covered by a given set may be relatively small, such that good coverage can be obtained with a relatively small set of software artifacts (e.g., N=10). In contrast, for software artifacts associated with a programming language (e.g., ABAP), a given set of software artifacts may cover a larger number of features and their sequence of combination. In such examples, a relatively large set of software artifacts may be used (e.g., N=100).

The test automate generation tool 230 generates a set of test automates 250, including corresponding test automates 252 for software artifacts 1 . . . N. Accordingly, the test automate generation tool 230 generates a corresponding test automate for each one of software artifacts 1 . . . N 212 (e.g., test automate 1 is generated for software artifact 1, test automate 2 is generated for software artifact 2, etc., until N test automates have been generated). For a given one of the software artifacts 1 . . . N 212, the corresponding one of the test automates 252 can include one or more references to the software artifact (e.g., the code of the test automate can include one or more calls to the software artifact). As shown, the set of test automates 250 is input to a mutant test automate creator 260, which corresponds to mutant test automate creator 124 of FIG. 1, as well as to a test automate executor, which corresponds to test automate executor 126 of FIG. 1.

Sets of mutated versions of software artifacts 280, which correspond to mutant software artifacts 154 of FIG. 1, are also input to the mutant test automate creator 260. In particular, the domain expert 240 creates sets of mutated versions for each of the software artifacts 1 . . . N 212, shown as sets of mutated versions 282 of software artifacts 1 . . . N.

Accordingly, the set of mutated versions 282 of software artifact 1 comprises a plurality of mutated versions of software artifact 1 212, the set of mutated versions 282 of software artifact 2 comprises a plurality of mutated versions of the software artifact 2, etc., for all N software artifacts in the set of software artifacts 210.

In some examples, each mutated version of a given one of the software artifacts 1 . . . N 212 includes exactly one mutation relative to the corresponding original software artifact, which may be an elementary mutation. Some examples of elementary mutations include a statement deletion, an operator replacement, a variable replacement, a constant replacement, and a condition negation. In a given set of mutated versions 282, each mutated version of the corresponding software artifact may have a different mutation (e.g., respective ones of the mutated versions of a given software artifact can include different mutations of the given software artifact). In other examples, a given mutated version of a software artifact may include more than one mutation, and/or a different type of mutation (e.g., a mutation other than an elementary mutation).

The sets of mutated versions of software artifacts 280 are input to the mutant test automate creator 260, which also received the set of test automates 250 as inputs as describe above. The mutant test automate creator 260 is configured to create sets of mutant test automates 290 by modifying the individual test automates 252. For example, the mutant test automate creator 260 can create a given mutant test automate of a set of mutant test automates 292 for software artifact 1 by replacing references to software artifact 1 in the code of test automate 252 for software artifact 1 with references to one of the mutated versions of software artifact 1 from the set of mutated versions 282 of software artifact 1. Towards this end, the mutant test automate creator can create a copy the code of the test automate 252 for software artifact 1, replace the references to software artifact 1 in the code with references to one of the mutated versions of software artifact 1 from the set of mutated versions 282 of software artifact 1, and populate a mutant test automate with the modified code. The mutant test automate creator 260 can repeat this process for each mutated version of the set of mutated versions 282 of software artifact 1, so as to create a corresponding set of mutant test automates 292 for software artifact 1.

The entire process can be repeated for each of the sets of mutated versions 282 and test automates 252, such that a corresponding set of mutant test automates 292 is created for each of the sets of mutated versions 282, and thus for each of software artifacts 1 . . . N 212.

As shown, the set of test automates 250 generated by the test automate generation tool 230 and the sets of mutant test automates 290 created by the mutant test automate creator 260 are input to the test automate executor 270. As described above with reference to FIG. 1, the test automate executor 270 can execute the test automates and mutant test automates to obtain test results indicating whether each one passed or failed. The test results can then be used to generate benchmark metrics for the test automate generation tool 230 which provide a quantitative quality measure of the test automate generation tool 230.

### Example 5

### Example Method of Performing a Quantitative Quality Assessment of a Test Automate Generation Tool

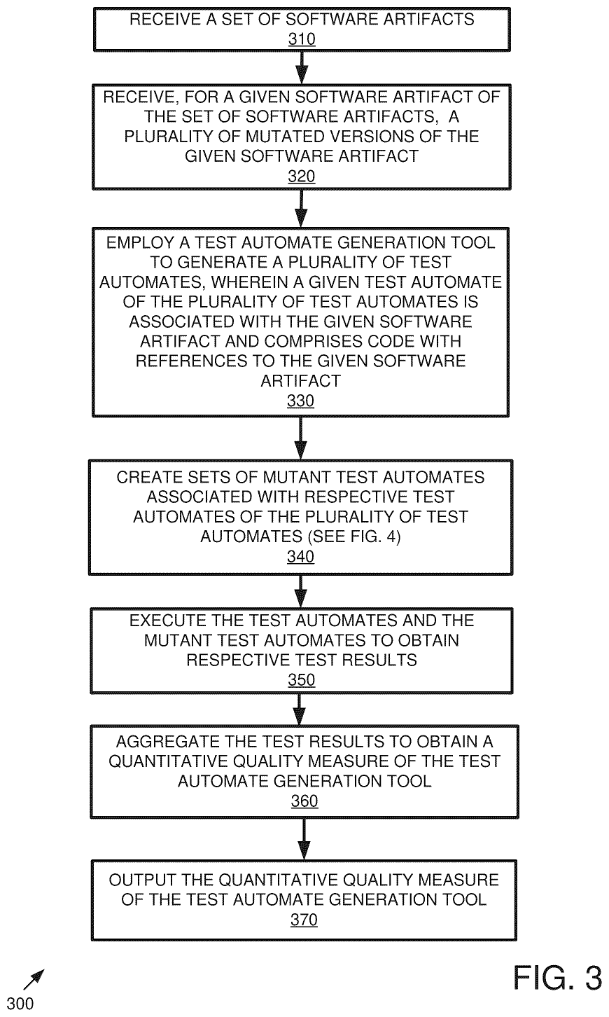

FIG. 3 is a flowchart of an example method 300 of performing a quantitative quality assessment of a test automate generation tool and can be performed, for example, by the system of FIG. 1. For example, the method 300 can be performed by the benchmark runner 120 in conjunction with other components of system 100 of FIG. 1.

In the example, at 310, a set of software artifacts is received. For example, a user with expertise in a particular software domain can select a set of software artifacts to serve as the subjects of test automates to be generated by a test automate generation tool. As shown in FIG. 1, the set of software artifacts can be received by a test automate creator of a benchmark runner.

At 320, for a given software artifact of the set of software artifacts, a plurality of mutated versions of the given software artifact are received. For example, a corresponding plurality mutated versions may be received at this step for each of the software artifacts in the set of software artifacts. As described herein, the mutated versions may be generated manually by a human expert (e.g., a domain expert) and then input to the benchmark runner.

At 330, a test automate generation tool is employed to generate a plurality of test automates, wherein a given test automate of the plurality of test automates is associated with the given software artifact and comprises code with references to the given software artifact.

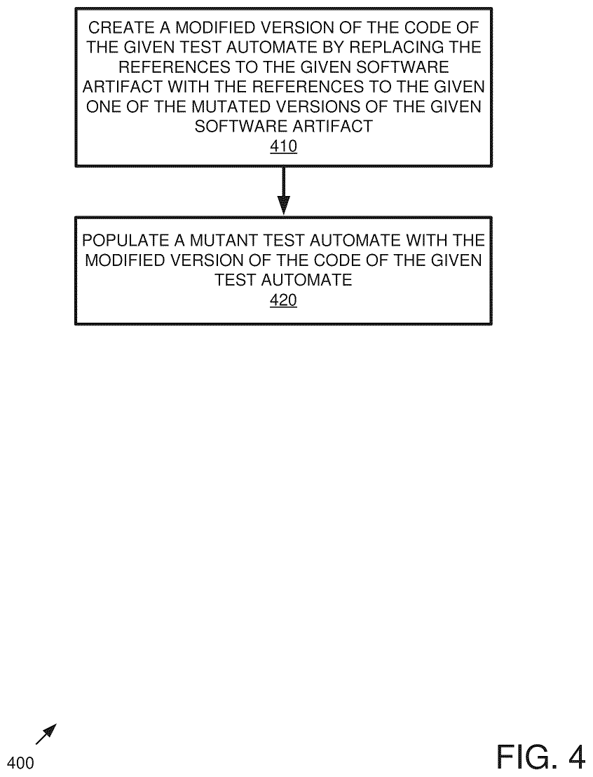

At 340, sets of mutant test automates associated with respective test automates of the plurality of test automates are created. Creation of the mutant test automates is described in further detail below with reference to FIG. 4.

At 350, the test automates and the mutant test automates are executed to obtain respective test results. For example, execution of a given test automate can produce a test result indicating that the test automate passed or failed. Similarly, execution of a given mutant test automate can produce a test result indicating that the mutant test automate passed or failed.

At 360, the test results are aggregated to obtain a quantitative quality measure of the test automate generation tool. As described further herein, benchmark metrics can be determined based on the test results, from which a quantitative quality measure of the test automate generation tool can be derived.

At 370, the quantitative quality measure of the test automate generation tool is output. For example, as described above with reference to FIG. 1, the quantitative quality measure can be output to a metrics monitor and regression alerter which generates and output alerts when the quality of the test automates (and thus, the performance of the test automate generation tool) has regressed. In some examples, regression of the test automate generation tool may occur due to degradation of the foundation model used by the generative AI service which is incorporated in the test automate generation tool. Such degradation can include data drifting, skewness change, etc.

In some examples, the outputting of the quantitative quality measure of the test automate generation tool prompts further actions. For example, software developers of the test automate generation tool may run the benchmark regularly during development in order to obtain feedback/direction on their ongoing development. When quantitative quality measure of the test automate generation tool indicates regression, the software developers may be alerted of the regression via generation of an incident report. The software developers can examine the incident report to determine why the quality of the test automate generation tool has deteriorated (e.g., by analyzing their logs, retriggering/debugging test generation requests as the ones used by the benchmark runner, checking whether a new version of the foundation model has been activated, etc.)

As another example, the outputting of the quantitative quality measure of the test automate generation tool can prompt further actions by data scientists of the foundation model. In particular, newly trained or fine-tuned versions of the foundation model can be tested by running the benchmark on the test automate generation tool (or on multiple test automate generation tools). This can advantageously provide early feedback on whether to release the new foundation model version.

As yet another example, a delivery manager software module for the test automate generation tool can receive the output quantitative quality measure. In this example, the output quantitative quality measure is a measure of a new version of the test automate generation tool which has not yet been delivered to users (e.g., released and/or deployed). Based on the value of the quantitative quality measure, the delivery manager can determine whether to release the new version of the test automate generation tool to users (e.g., software engineers and quality engineers), or block release of the new version of the test automate generation tool and instead maintain operation of a currently deployed version of the test automate generation tool. In a continuous delivery setup, the determination may be made at regular intervals (e.g., daily), and optionally in an automated manner (e.g., such that new versions of the test automate generation tool are delivered to users automatically if no regressions were found).

Further, a system administrator for users of the test automate generation tool (e.g., software engineers or quality engineers) can receive the output quantitative quality measure and use it to determine which version of the test automate generation tool to make accessible to users. Towards this end, the system administrator can run the benchmark as an inbound qualification of a new version of the test automate generation tool. Depending on the resulting quantitative quality measure, the system administrator can opt to allow user access to the new version of the test automate generation tool (e.g., if the measure is above a predefined threshold), or maintain user access to a current version of the test automate generation tool (e.g., a current version which attained a quantitative quality measure above the threshold during prior benchmarking).

For example, the test automate generation tool undergoing benchmarking via method 300 may be a new version of a currently deployed test automate generation tool. The method 300 can optionally include obtaining a quantitative quality measure of the currently deployed test automate generation tool (e.g., a quantitative quality measure of the currently deployed test automate generation tool measured during a prior iteration of method 300 and stored in memory), and comparing the quantitative quality measure of the new version of the test automate generation tool to the quantitative quality measure of the currently deployed test automate generation tool. Depending on the result of the comparison, the new version of the test automate generation tool may be either released or blocked. For example, it may be determined, based on the comparing, that the quantitative quality measure of the new version of the test automate generation tool is less than the quantitative quality measure of the currently deployed test automate generation tool. In this case, an indication of a quality regression of the new version of the test automate generation tool may be output. Responsive to the indication of quality regression of the new version of the test automate generation tool, release of the new version of the test automate generation tool may be blocked (e.g., the new version may be flagged as unavailable for release by a delivery manager software module of the test automate generation tool). In this case, the currently deployed test automate generation tool may be used until the new version of the test automate generation tool achieves an acceptable quantitative quality measure (e.g., a quantitative quality measure above a predetermined threshold).

The method 300 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, receiving a set of software artifacts can be described as sending a set of software artifacts depending on perspective.

### Example 6

### Example Method of Creating a Mutant Test Automate

FIG. 4 is a flowchart of an example method 400 of creating a mutant test automate and can be performed, for example, by the system of FIG. 1, in conjunction with method 300 of FIG. 3. For example, the method 400 can be performed by the benchmark runner 120 in conjunction with other components of system 100 of FIG. 1. Method 400 can be performed at step 340 of method 300, for example. While method 400 describes creation of a single mutant test automate for case of explanation, a plurality of mutant test automates may be created in practice, e.g., in parallel or sequentially.

In the example, at 410, a modified version of the code of a given test automate is created by replacing references to a given software artifact with references to a given one of the mutated versions of the given software artifact. For example, the code of a given test automate may include one or more references to a software artifact (e.g., a software artifact which is being tested by the test automate). The mutant test automate creator of the benchmark runner can create new code for a mutant test automate by taking the code of the given test automate and replacing each reference to the given software artifact therein with a reference to the given one of the mutated versions of the given software artifact. Put another way, a mutant version of the test automate is created in which all instances of the name of the given software artifact are replaced with the name of the given one of the mutated versions of the given software artifact.

At 420, a mutant test automate is populated with the modified version of the code of the given test automate. This can include, for example, populating a software object (e.g., an XML object, a JSON object, a .Java file, or another type of software object) with the modified version of the code. The resulting mutant test automate can then be saved in a test automate store (e.g., test automate store 160 of FIG. 1), and ultimately input to a test automate executor for validation (e.g., test automate executor 126 of FIG. 1).

### Example 7

### Example Metrics

In any of the examples herein, the benchmark runner can output benchmark metrics from which a quantitative quality measure of a test automate generation tool can be derived. In contrast to typical qualitative approaches for assessing the performance of test automate generation tools, the quantitative quality measure produced by the disclosed techniques provides quantitative information that can be monitored to accurately identify regressions or other changes in the behavior of the test automate generation tool.

When a test automate generation tool is performing correctly, the generated test automates for the original software artifacts should pass (i.e., run successfully), whereas the mutant test automates should fail. However, in accordance with the disclosed techniques, multiple mutant test automates are created for each test automate (i.e., for each test automate based on an original software artifact). Accordingly, the benchmark metrics must take into account this massive bias (unbalanced population).

From a statistical perspective, the test automates and mutant test automates act as binary classifiers. Accordingly, metrics associated with binary classifiers can be derived from the pass/fail test results generated by executing the test automates and mutant test automates.

A confusion matrix can be used to illustrate certain aspects of the benchmark metrics. Towards this end, Θ and M can denote the set of original software artifacts and the set of mutants (i.e., mutated versions of the original software artifacts) respectively. Furthermore, the set Θₛ includes the original software artifacts for which the generated test automates run successfully, and Θ_{f} includes the original software artifacts for which the generated test automates fail. The sets Mₛ and M_{f} are defined analogously for the mutants. Furthermore, let the sets S:=Mₛ+Θₛ and F:=M_{f}+Θ_{f} denote the tests that succeed and fail, respectively. This can be illustrated by the following confusion matrix:

TABLE 1
Confusion Matrix

| Software artifact | Test fails | Test succeeds |
|---|---|---|
| type | (mutation reported) | (no mutation reported) |
| Mutant software | M_{f} | Mₛ |
| artifact | true positive | false negative |
| Original software | Θ_{f} | Θₛ |
| artifact | false positive | true negative |

Metrics can be derived from the confusion matrix. However, the bias needs to be addressed. This can be achieved by separating the accuracy of test results for original software artifacts from the accuracy of the test results for the mutant software artifacts. The key ratios for this are as follows: sensitivity (true positive rate, recall):

$$SEN = \frac{\vert {M}_{f} \vert}{\vert M \vert} ;$$

and specificity (true negative rate):

$$SPC = \frac{\vert {Θ}_{s} \vert}{\vert Θ \vert} .$$

A balanced accuracy metric can be derived from the sensitivity and specificity as follows:

$$BACC = \frac{SEN + SPC}{2} .$$

Examples values of sensitivity, specificity, and balanced accuracy are illustrated in Table 2 below, along with comments.

TABLE 2
Example Values of SEN, SPC, and BACC

| SEN | SPC | BACC | Comments |
|---|---|---|---|
| 100% | 100% | 100% | Perfect score |
| 0% | 0% | 0% | Worst score; also applies if generated test |
| | | | automate cannot be activated |
| 100% | 0% | 50% | Always fail; trivial lower bound for BACC |
| 0% | 100% | 50% | Always succeed; trivial lower bound for BACC |
| 90% | 50% | 70% | |
| 30% | 70% | 50% | |
| 40% | 100% | 70% | |

The sensitivity, specificity, and balanced accuracy metrics are sometimes referred to as simple metrics. There are some drawbacks to using simple metrics. For example, the trivial lower bound is 50%, which is counterintuitive. Further, sensitivity is assigned the same weight as specificity. However, successful tests on the original software tests are the basis of any regression test. Therefore, a higher weight can be given to specificity.

It may be argued that it is more important to test the original software artifact successfully than to detect every mutation. In this case, a higher weight can be given to averting false positives. This corresponds with weighting for the F₂ score, which combines recall and precision metrics and gives recall double the weight of precision; however, the recall is substituted by the specificity. The resulting equation, referred to as the harmonic mean of sensitivity and specificity (double weight) can be defined as

$${SHM}_{2} = \frac{5 \cdot SEN \cdot SPC}{4 \cdot SEN \cdot SPC} .$$

Examples values of sensitivity, specificity, balanced accuracy, and SHM₂ are illustrated in Table 3 below, along with comments.

TABLE 3
Example Values of SEN, SPC, BACC, and SHM₂

| SEN | SPC | BACC | SHM₂ | Comments |
|---|---|---|---|---|
| 100% | 100% | 100% | 100% | Perfect score |
| 0% | 0% | 0% | 0% | |
| 100% | 0% | 50% | 0% | |
| 0% | 100% | 50% | 0% | |
| 90% | 50% | 70% | 55% | SHM₂ awards lower score |
| | | | | than BACC because |
| | | | | false positives are frequent |
| 30% | 70% | 50% | 58% | SHM₂ awards higher score |
| | | | | than BACC because |
| | | | | false positives are infrequent |
| 33% | 67% | 50% | 56% | Randomly succeed with 67%; |
| | | | | trivial lower bound for SHM₂ |
| 40% | 100% | 70% | 77% | |

Another metric that can be used for binary classifiers on unbalanced populations is the Matthews Correlation Coefficient, which can be defined as

$$MCC = \frac{\vert {M}_{f} \vert \cdot \vert {Θ}_{s} \vert - \vert {M}_{s} \vert \cdot \vert {Θ}_{f} \vert}{\sqrt{\vert M \vert \cdot \vert Θ \vert \cdot \vert F \vert \cdot \vert S \vert}} .$$

It may also be argued that it is more important to test the original software artifact successfully than to detect every mutation. The F₁ score of the original software artifacts as the minority class is able to capture this, even in the presence of class imbalances. However, the degree of the imbalance still needs to be considered in order to assess the meaning of the valuation of the metric. The F₁ score can be defined as

$${F}_{1} = \frac{2 \cdot \vert {Θ}_{s} \vert}{\vert Θ \vert + \vert S \vert} .$$

Examples values of MCC and F₁ for different set quantities are illustrated in Table 4 below, along with comments. In the example shown in Table 4, there is one original software artifact and 15 mutants (i.e., 15 mutated versions of the original software artifact).

TABLE 4
Example Values of MCC and F₁

| \|M_{f}\| | \|Ms\| | \|θ_{f}\| | \|θₛ\| | MCC | F₁ | Comments |
|---|---|---|---|---|---|---|
| 15 | 0 | 0 | 1 | 1.0 | 1.0 | Perfect score |
| 0 | 15 | 1 | 0 | −1.0 | 0.0 | Worst score |
| 15 | 0 | 1 | 0 | undefined | 0.0 | Always fail |
| 0 | 15 | 0 | 1 | undefined | 0.1 | Always succeed |
| 15 | 15 | 1 | 1 | 0.0 | 0.1 | Randomly succeed with 50%; |
| | | | | | | trivial lower bound for MCC |
| 6 | 9 | 0 | 1 | 0.2 | 0.2 | |
| 6 | 9 | 1 | 0 | −0.3 | 0.0 | Same as above but original |
| | | | | | | software artifact fails |
| 12 | 3 | 0 | 1 | 0.4 | 0.4 | Original software artifact |
| | | | | | | succeeds and 80% of the |
| | | | | | | mutants are detected |

In any case, the quantitative quality measure of the test automate generation tool can be a numerical value calculated based on various metrics derived from the pass/fail test results of the test automates and mutant test automates, such as those described above.

### Example 8

### Use Cases

The technologies described herein can be applied in a variety of scenarios. For example, the test automate generation tool can be configured to generate test automates for a particular category of software artifacts such as a set of virtual data model objects; a set of SQL views; a set of classes (e.g., ABAP classes); or a set of scripts (e.g., Python scripts or scripts in another programming language).

In an example where set of software artifacts is a set of SQL views, the number of possible statements that might be included in a SQL view may be too large to be included in a single SQL view. Accordingly, a plurality of SQL views (e.g., 20 SQL views) may be selected which collectively include all possible statements. For example, one of the SQL views in the set could cover UNION operations, another of the SQL views in the set could cover GROUP BY clauses, etc.

As noted above, in some examples, the category of software artifacts is a set of virtual data model objects. A virtual data model can represent an abstraction of data stored in another data store, such as an abstraction of tables or views of a relational database system. Objects in the virtual data model can be defined with respect to objects in a database, but can be more easily understandable and manipulable by users, particularly users with less technical knowledge. Examples of virtual data models include those implemented using CDS technology of SAP SE, of Walldorf, Germany. For example, a virtual data model can include a plurality of virtual data model objects referred to as CDS views. CDS views can be used to define structured data models that combine data from various sources, such as database tables, other CDS views, and external sources. The CDS views can be defined on top of application data tables to represent a semantic data model. CDS views can hide cryptic database models and wrap them into human-understandable entities, containing domain-specific metadata or annotations.

A given CDS view can be made up of up to two parts. In particular, each CDS view includes a Data Definition Language (DDL) object (e.g., a DDL software artifact); some CDS views also include, in addition to the DDL object, a Data Control Language (DCL) object (e.g., a DDL software artifact). A given DDL object serves to define which data is returned when selecting from the corresponding CDS view, whereas a given DCL object serves to define which result rows are visible to the end user based on their authorization level.

In one example use case, several CDS views can be selected which collectively cover every aspect of CDS views (e.g., such that for any aspect such as filter and join criteria, Perfectly Functionally Co-coordinating Group (PFCG) role conditions, CDS functions, conditional statements, aggregations, and unions, the aspect is included in at least one CDS view within the chosen set). The selected CDS views may need to be adjusted to obtain desired criteria (e.g., orthogonality). The selected CDS views can be stored separately from the active code base to allow for such adjustments and decouple any changes from the active code base.

In this example use case, several mutant CDS views can be derived by applying exactly one elementary mutation at a time. This is a manual process which requires an advanced understanding of test engineering and a clear strategy regarding which potential regressions should be covered. In this context, an elementary mutation can be defined as a minimal change to the DDL or DCL that a “good” test would detect. Some examples of such elementary mutations are illustrated in Table 5 below.

TABLE 5
Example Elementary Mutations for CDS Views

| Elementary | | |
|---|---|---|
| Mutation Type | Original code | Mutated code |
| Filter/join criteria | item.OrderItem = ‘0001’ | item.OrderItem = ‘0002’ |
| PFCG role conditions | (Plant) ?= aspect pfcg_auth | (Plant) = aspect pfcg_auth |
| | (M_MATE_WRK, WERKS, | (M_MATE_WRK, WERKS, |
| | actvt = ‘03’ | actvt = ‘03’ |
| | ( . . . 0 - aspect pfcg_auth ( . . . ) | ( . . . 0 - aspect pfcg_auth ( . . . ) |
| | AND ( . . . ) - aspect pfcg_auth ( . . . ); | OR ( . . . ) - aspect pfcg_auth ( . . . ); |

In the CDS view example, during runtime, a validation run starts with the test automate generation tool generating a test automate (e.g., test code) for each of the original CDS views, but not for the mutants. The obtained test code is put into test automates, which can alternatively be referred to as dedicated test classes (one class for each CDS view), and activated. If the activation fails, the validation terminates early. For each of the test automates, copies are created and activated for all of the mutants. Towards this end, as described herein, every mention of the CDS view (i.e., the code-under-test (CUT)) is substituted with the name of the corresponding mutant. The test automates for the mutants are also activated, and then the test automates for the CDS view and its mutants are executed. Notably, the steps can be performed programmatically (e.g., automatically, without human intervention). If desired, the steps can follow a deterministic heuristic that can be implemented by a traditional computer program.

The results of the execution of the test automates for the CDS view and its mutants are collected. All tests on the original CDS views are expected to pass (e.g., run successfully), whereas, for each mutant, there is expected to be at least one failed test method. The final validation aggregates these findings according to binary classifier metrics (e.g., balanced accuracy), as described herein.

Table 6 below illustrates a plurality of example elementary mutation types which collectively form an example mutation strategy for DCL mutants.

TABLE 6
Example DCL Mutation Strategy

| Mutant | |
|---|---|
| Type | Focus |
| MC0 | Change first operator from AND to OR |
| MC1 | Change second operator from AND to OR |
| MC2 | Remove first condition |
| MC3 | Remove second condition |
| MC4 | Remove third condition |
| MC5 | Change first condition: activity from ‘03’ to ‘F4’ |
| MC6 | Change second condition: ProductionPlant to PlanningPlant |
| MC7 | Change third condition: Authorization object C_AFKO_AWK |
| | to C_AFKO_CST |

Table 7 below illustrates a plurality of example elementary mutation types which collectively form an example mutation strategy for DDL mutants.

TABLE 7
Example DDL Mutation Strategy

| Mutant | |
|---|---|
| Type | Focus |
| MD0 | Remove filter for OrderCategory on 10 |
| MD1 | Remove filter for OrderCategory on 40 |
| MD2 | CASE removed from OrderHasLongText (‘Z’ no longer mapped |
| | to ‘ ’) |
| MD3 | Switch from INNER JOIN to LEFT OUTER JOIN |
| MD4 | Remove OrderID from join criteria |
| MD5 | Remove OrderItem from join criteria |
| MD6 | Change OrderItem literal |

### Example 9

### Example Original and Mutant Software Artifacts

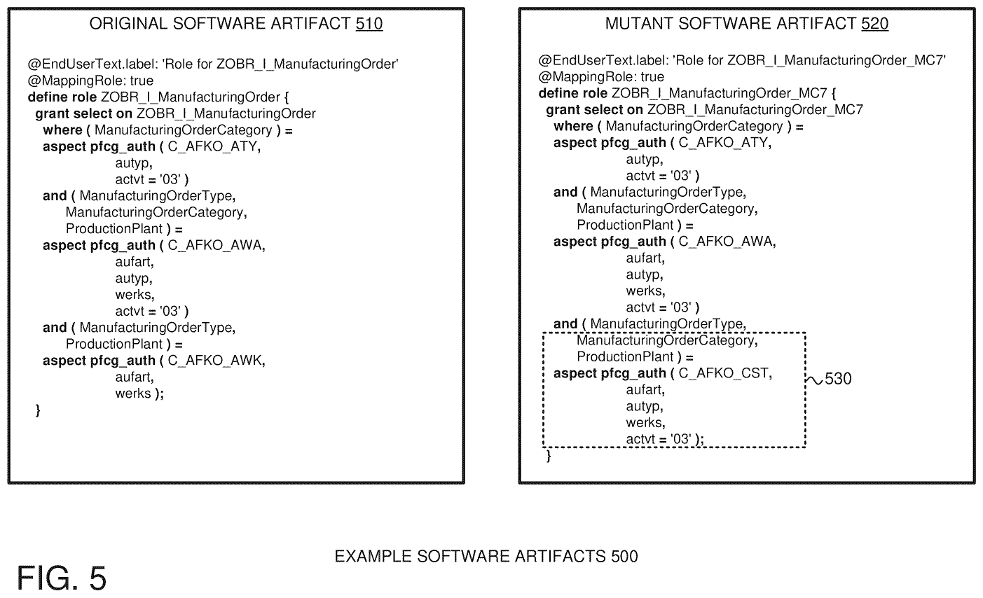

FIG. 5 is a block diagram of example software artifacts 500 which are DCL objects. An original software artifact 510 is depicted along with a mutant software artifact 520, which is a mutated version of the original software artifact 510.

As shown, mutant software artifact 520 contains exactly one elementary mutation of original software artifact 510, but is otherwise identical to original software artifact 510. As shown at 530, the mutant software artifact 520 includes a mutation of mutant type MC7 shown in Table 6 (i.e., the third condition has been changed from “C_AFKO_AWK” to “C AFKO CST”, and ManufacturingOrderCategory has been added to the tuple).

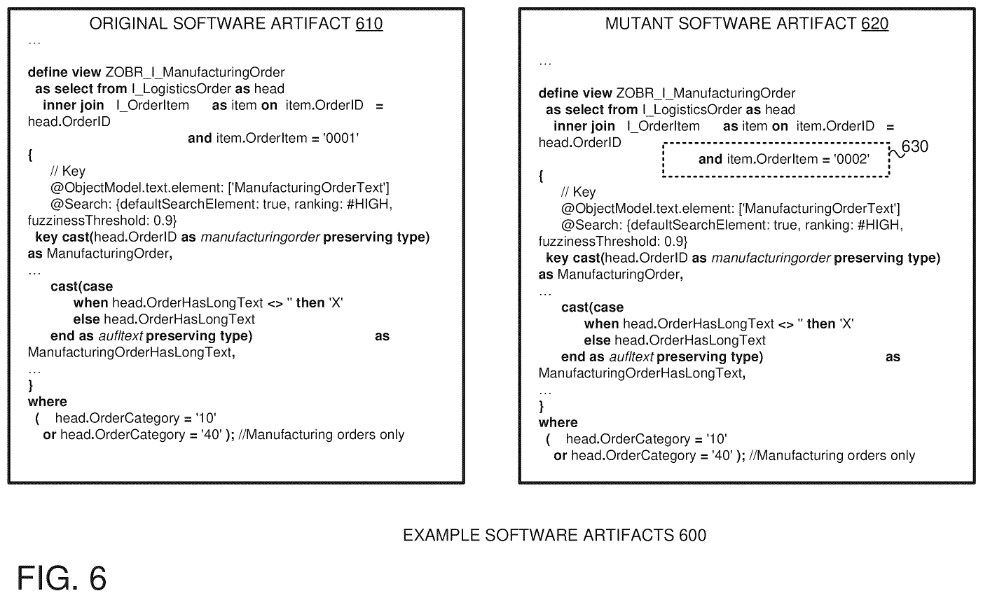

FIG. 6 is a block diagram of example software artifacts 600 which are DDL objects. An original software artifact 610 is depicted along with a mutant software artifact 620, which is a mutated version of the original software artifact 610. Here again, as indicated by the ellipsis marks, only part of the code of these objects is depicted for the sake of brevity.

In the example, mutant software artifact 620 contains exactly one elementary mutation of original software artifact 610, but is otherwise identical to original software artifact 610. As shown at 630, the mutant software artifact 620 includes a mutation of mutant type MD6 shown in Table 7 (i.e., the OrderItem literal has been changed from ‘0001’ to ‘0002’).

### Example 10

### Example Modified System Implementing Assessment of Test Automate Generation Tools for Test-Driven Development Use Case

In some situations, such as during test-driven development, the software artifact to be tested is not yet fully available. A modified version of the technologies described above can implemented in such situations.

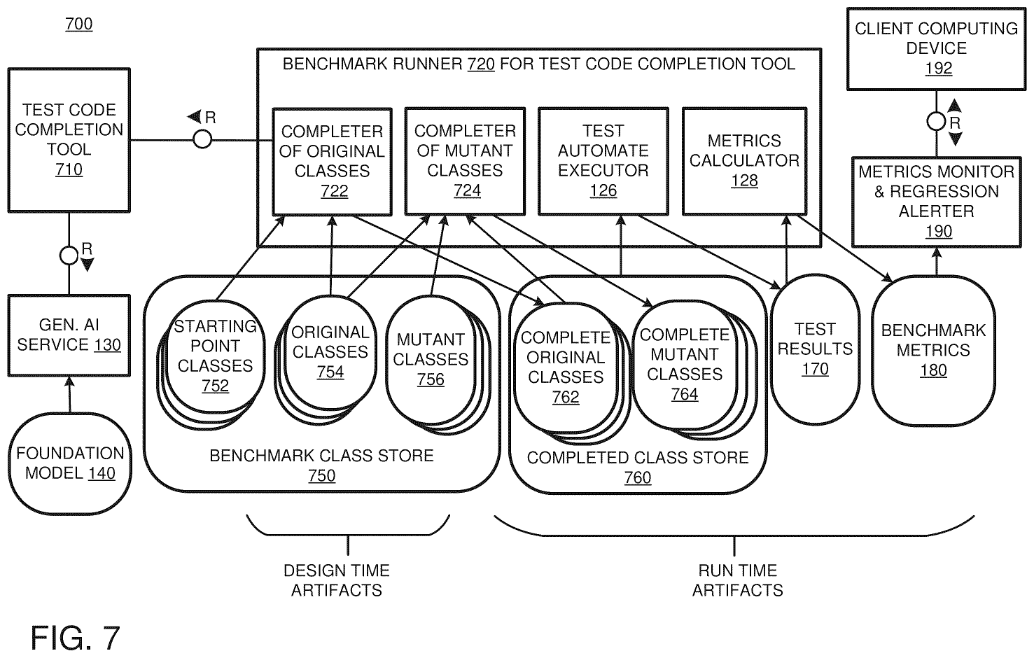

FIG. 7 is a block diagram of a system 700 which is a modified version of system 100 of FIG. 1. Whereas system 100 implements assessment of a test automate generation tool, system 700 implements assessment of a test code completion tool. The components shown in FIG. 7 are numbered consistently with FIG. 1, except where new or modified elements are introduced; the description of like-numbered elements for FIG. 1 can also be applied to FIG. 7. While system 700 depicts an example in which the software artifacts to be tested are classes (e.g., ABAP classes), other types of software artifacts could alternatively serve as test subjects in conjunction with system 700.

In the example, the system 700 includes a test code completion tool 710 and a benchmark runner 720 for the test code completion tool 710. The test code completion tool 710 employs the generative AI service 130, which in turn employs the foundation model 140.

A benchmark class store 750 stores starting point classes 752, original classes 754, and mutant classes 756, which serve as inputs to a benchmark runner 720 and can be considered as design time artifacts. The starting point classes 752 are incomplete versions of classes which are being developed by a software developer of team of software developers, whereas the original classes 754 and mutant classes 756 are generated by a domain expert (e.g., a software engineer with expertise in the domain associated with the set of software artifacts). In particular, a given one of the original classes 754 is generated by the domain expert based on a corresponding one of the starting point classes 752, and a given one of the mutant classes 756 is generated by the domain expert based on a corresponding one of the original classes 754.

Each of the starting point classes 752 includes (i) incomplete productive code and (ii) incomplete test code (e.g., incomplete code for a unit test). Each one of the original classes 754 is a modified version of a corresponding one of the starting point classes 752, which represents a target state of the productive code. In particular, a given one of the original classes 754 includes: (i) complete productive code which was generated by the domain expert as a prediction based on the incomplete productive code in the corresponding one of the starting point classes 752; and (ii) a modified version of the incomplete test code of the corresponding one of the starting point classes 752. In the modified version of the incomplete test code, a placeholder is inserted (e.g., by the domain expert) to indicate where the benchmark runner 720 should insert predicted code generated by the test code completion tool 710. For example, the domain expert may determine where to insert the placeholder based on a cursor position in the corresponding one of the starting point classes 752, which in turn represents where the software developer who created that starting point class left off (e.g., their stopping point).

A plurality of mutant classes 756 (e.g., a corresponding set of mutant classes 756) may be generated by the domain expert for each of the original classes 754. For example, similar to the mutant software artifacts described above, the mutant classes 756 can be understood as mutated versions of the original classes 754. A given one of the mutant classes 756 includes: (i) a mutated version of the complete productive code of the corresponding one of the original classes 754; and either (ii) the same modified version of the incomplete test code included in the corresponding one of the original classes 754 or (iii) a different modified version of the incomplete test code included in the corresponding one of the original classes 754. In particular, the productive code of each of the mutant classes 756 includes at least one mutation relative to the productive code of the corresponding one of the original classes 754. In some examples, the productive code of a given one of the mutant classes 756 includes exactly one elementary mutation relative to the productive code of the corresponding one of the original classes 754. The test code of the mutant classes 756 is either not modified relative to the test code of the corresponding one of the original classes 754, or modified relative to the test code of the corresponding one of the original classes 754 (e.g., to include an additional mutation). The mutant classes 756 are alternatively referred to herein as mutant target states, as they include mutated versions of the target state of the productive code.

To better illustrate the relationship between the starting point classes 752, original classes 754, and mutant classes 756, example Python code is shown in Table 8 below. In other examples, the code may be written in another programming language (e.g., ABAP).

TABLE 8
Example Starting Point Class, Corresponding Original
Class, and Corresponding Mutant Class

| Class Type | Productive Code | Test Code |
|---|---|---|
| starting | class Calculator: | from calc import Calculator |
| point class | def add(self, num1, num2): | def test_add( ): |
| | pass # TBD | #<CURSOR> |
| original | class Calculator: | from calc import Calculator |
| class | def add(self, num1, num2): | def test_add( ): |
| | return num1 + num2 | #<PREDICTED_CODE> |
| mutant | class Calculator: | from calc import Calculator |
| class | def add(self, num1, num2): | def test_add( ): |
| | return num1 − num2 | #<PREDICTED_CODE> |

In the above example, the last line of the productive code of the starting point class reads “pass #TBD”; in the corresponding original class, the domain expert has replaced that line with “return num 1+num2” which represents an expected target state of that line of the productive code. Put another way, the domain expert has predicted that “return num1+num2” is what the software developer who created the starting point class would have written if they had completed development of the class. The last line of the test code of the starting point class reads #<CURSOR>″, which indicates that a cursor position of the software developer who created the starting point class was recorded at that line. In the corresponding original class, “#<CURSOR>” has been replaced with a “#<PREDICTED_CODE>” tag, which serves as a placeholder for where the benchmark runner 720 will insert the predicted code received from the test code completion tool 710 to complete the test code in the corresponding original class and mutant classes.

Continuing with the above example, the productive code of the mutant class is identical to that of the original class, except that a single elementary mutation has been made in the last line. In particular, the “+” has been replaced with a “−” in this line. The test code of the mutant class can either be identical to that of the original class or mutated relative to the test code of the original class. While a single mutant class is depicted in Table 8 for the sake of brevity, there will typically be multiple mutant classes for each original class (and thus, for each starting point class) in practice.

Returning to FIG. 7, the benchmark runner 720 can include software designed to execute benchmark tests to obtain a quantitative quality measure of the output of the test code completion tool 710. Towards this end, the benchmark runner 720 includes a completer of original classes 722, a completer of mutant classes 724, the test automate executor 126, and the metrics calculator 128, which can be implemented as individual software modules. The completer of original classes 722 receives starting point classes 752 and original classes 754 as inputs. To employ the test code completion tool 710 to perform code completion for a given one of the starting point classes 752, the completer of original classes 722 sends a request to an API of the test code completion tool 710. The request includes the given one of the starting point classes 752.

The test code completion tool 710 can be configured to utilize the generative AI service 130 to autonomously perform code completion of the test code of the starting point classes 752. In particular, for a given one of the starting point classes 752, the test code completion tool 710 can employ the generative AI service 130 to generate predicted code for the given starting point class in the form of a text string. The generation of the predicted code may take into account the cursor position in the test code of the starting point class.

The test code completion tool 710 provides the predicted code to the completer of original classes 722 as a string, which in turn replaces the placeholder of the test code of the original class corresponding to the given one of the starting point classes 752 with the predicted code, in order to generate a completed version of that original class. As shown, the completed versions of the original classes are stored in a completed class store 760 as complete original classes 762. The completer of mutant classes 724 then receives the complete original classes 762 as inputs, along with the original classes 754 and the mutant classes 756 of the benchmark class store 750. The completer of mutant classes 724 creates a corresponding set of complete mutant classes 764 for each of the complete original classes 762. In particular, to create a given one of the complete mutant classes 764, the completer of mutant classes 724 obtains the predicted code generated by the test code completion tool 710 from the corresponding one of the complete original classes 762 and replaces the placeholders in the test code of the mutant classes 724 with the predicted code to generate complete mutant classes 764. For example, a corresponding set of complete mutant classes 764 can be created for each of the complete original classes 762 (and thus, for each of the original classes 754). Notably, each of the complete mutant classes 764 is associated with a corresponding one of the mutant classes 756, which in turn is a mutated version of one of the original classes 754.

In some examples, the predicted code received from the test code completion tool 710 for the given starting point class does not include any references to productive code. In other examples, however, the predicted code includes one or more references to the name of the productive code of the given starting point class 752. In such examples, when generating a complete original class 762 based on the given starting point class 752 and after inserting the predicted code into the test code, the completer of original classes 722 can replace references to the name of the productive code of the given starting point class 752 in the predicted code with references to the name of the productive code of the corresponding original class 754.

Relatedly, during creation of a given complete mutant class 764 based on a given complete original class 762, it may be appropriate for the completer of mutant classes 724 to replace references. For example, if the test code of the given complete original class 762 includes references to the name of the productive code of a given original class 754, the completer of mutant classes 724 can replace those references with references to the name of the productive code of a corresponding mutant class 756 (i.e., the mutant class 756 which serves as the basis for the given complete mutant class 764). Towards this end, the completer of mutant classes 724 comparing the given original class 754 and the given complete original class 762 in order to infer how the test code of the given complete original class 762 was completed. The completer of mutant classes 724 can complete the test code of the given complete mutant class 764 with the predicted code based on this inference and replace any references to the name of the productive code of the given original class 754 in the predicted code with references to the name of the productive code of the corresponding mutant class 756.

The complete original classes 762 and the complete mutant classes 764 can then be input to the test automate executor 126 and run by the test automate executor 126 to generate the benchmark metrics, in the same manner described above with reference to FIG. 1.

Table 9 below includes examples of code predictions that may be generated by the test code completion tool 710 to complete the test code in the example original class shown in Table 8, along with corresponding test results for the resulting complete original classes 762 and complete mutant classes 764.

TABLE 9
Example Test Code Predictions and Results

| Example predicted code | Result |
|---|---|
| calculator = Calculator( ) | The complete original class will pass and the |
| assert calculator.add(1, | complete mutant class will fail (as desired). |
| 2) == 3 | |
| calculator = Calculator( ) | The complete original class and the complete |
| assert calculator.add(1, | mutant class will both pass (bad sensitivity). |
| 0) == 1 | |
| calculator = Calculator( ) | This prediction misses the hint of the cursor |
| assert calculator.sub(4, | position within test_add; this leads to the |
| 3) == 1 | complete original class and the mutant class |
| | both failing (bad specificity). |

### Example 11

### Example Method of Performing a Quantitative Quality Assessment of a Test Code Completion Tool

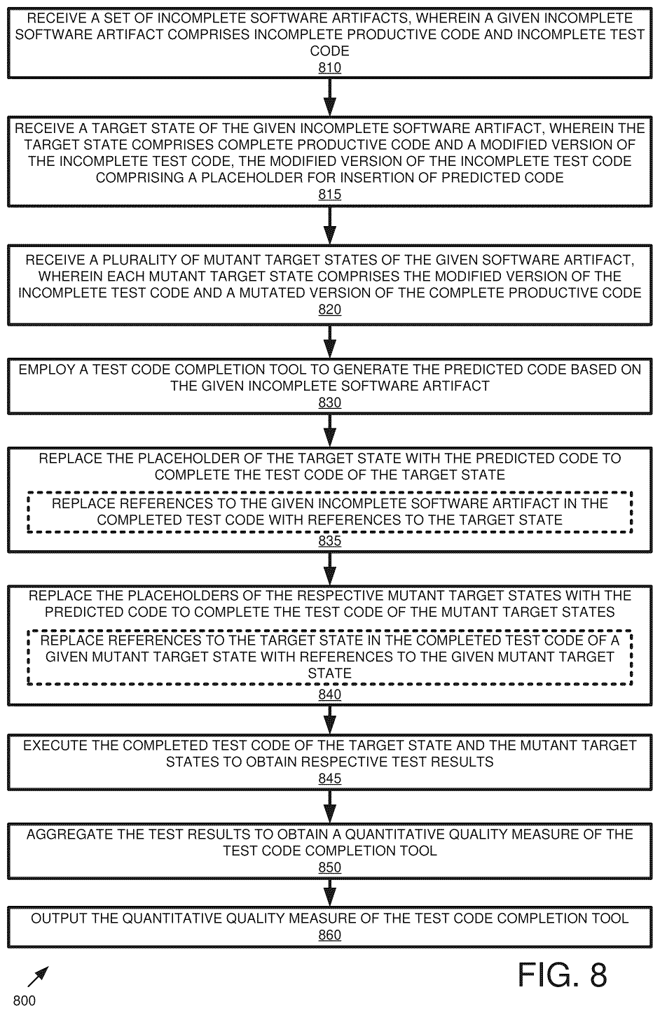

FIG. 8 is a flowchart of an example method 800 of performing a quantitative quality assessment of a test code completion tool and can be performed, for example, by the system of FIG. 7. For example, the method 800 can be performed by the benchmark runner 720 in conjunction with other components of system 700 of FIG. 7.

In the example, at 810, a set of incomplete software artifacts is received, wherein a given incomplete software artifact comprises incomplete productive code and incomplete test code. The incomplete software artifacts can alternatively be referred to as “starting point” software artifacts (e.g., starting point classes 752 of FIG. 7). Optionally, the given incomplete software artifact can include an indication of a cursor position in the test code, which may serve as an indicator of where the software developer left off during development of the test code.

At 815, a target state is received for the given incomplete software artifact, which comprises complete productive code and a modified version of the incomplete test code. The modified version of the incomplete test code comprises a placeholder for insertion of predicted code. In the example shown in FIG. 7, the original classes 754 can alternatively be referred to as target states of the starting point classes 752. At 820, a plurality of mutant target states of the given software artifact are received, wherein each mutant target state comprises the modified version of the incomplete test code and a mutated version of the complete productive code. In the example shown in FIG. 7, the mutant classes 754 can alternatively be referred to as mutant target states.

In practice, a plurality of target states may be received at 815 (e.g., one target state for each of the incomplete software artifacts), and a plurality of sets of mutant target states may be received at 820 (e.g., one set of mutant target states for each of the incomplete software artifacts). For example, a user with expertise in a particular software domain can select a set of incomplete software artifacts as candidates for completion by a test code completion tool. The user can generate the corresponding target state for each incomplete software artifact based on the user's prediction of how the productive code should be completed (e.g., the user's prediction of how the productive code was intended to be completed by the software developer who wrote the incomplete productive code). The user can also insert a placeholder into the incomplete test code for insertion of predicted code, e.g., based on a cursor position in the incomplete test code which represents where the software developer who created the incomplete test code left off. The user can then generate, for each target state, a corresponding set of mutant target states, wherein each mutant target state has a different mutation of the complete productive code (e.g., one elementary mutation of the complete productive code per mutant target state). The received set of incomplete software artifacts, target states, and mutant target states can be input to a benchmark runner for the test code completion tool (e.g., benchmark runner 720 of FIG. 7).

At 830, a test code completion tool is employed to generate the predicted code based on the given incomplete software artifact. For example, the benchmark runner can send a request to an API of the test code completion tool which includes the incomplete software artifact. As described herein, the test code completion tool can be configured to utilize a generative AI service to generate the predicted code.

At 835, the placeholder of the target state is replaced with the predicted code to complete the test code of the target state. Optionally, if the completed test code includes references to the given incomplete software artifact (e.g., references to the name of the incomplete productive code of the given incomplete software artifact), the references are replaced with references to the target state (e.g., references to the name of the complete productive code of the target state). Step 835 may be performed by the benchmark runner. For example, for the class-specific example shown in FIG. 7, the completer of original classes 722 receives the predicted code from the test code completion tool 710 for a given one of the original classes 754 and replaces the placeholder in the given one of the original classes 754 with the predicted code. If the completed test code includes references to the name of the productive code of the corresponding starting point class 752, the references are replaced with references to the name of the productive code of the given one of the original classes 754. The completer of original classes 722 then stores the result as a complete original class 762 in the completed class store 760.

At 840, the placeholders of the respective mutant target states are replaced with the predicted code to complete the test code of the mutant target states. Optionally, if the completed test code of the mutant target states includes references to the target state (e.g., references to the name of the productive code of the target state), the references are replaced with references to the mutant target states (e.g., references to the names of the productive code of the mutant target states). In particular, the references to the name of the productive code of the target state in the complete test code of a given one of the mutant target states can be replaced with references to the name of the productive code of the given one of the mutant target states). Step 840 may also be performed by the benchmark runner.

For example, for the class-specific example shown in FIG. 7, the completer of mutant classes 724 receives the original classes 754 from the benchmark class store and the complete original classes 762 from the completed class store. The completer of mutant classes 724 infers the predicted code to be inserted in the incomplete test code of a given mutant class 756 by comparing the corresponding original class 754 with its corresponding complete original class 762. Based on the inference, the completer of mutant classes 724 replaces the placeholder in the given mutant class 756 with the predicted code. If the completed test code for a given one of the mutant classes 756 includes references to the corresponding original class 754 (e.g., references to the name of the productive code of the corresponding original class 754), the references are replaced with references to the given one of the mutant classes 756 (e.g., references to the name of the productive code of the given one of the mutant classes 756). The completer of mutant classes 724 then stores the result as a complete mutant class 764 in the completed class store 760.

At 845, the completed test code of the target state and the mutant target states is executed to obtain respective test results. For example, execution of the test code of a given target state can produce a test result indicating that the target state passed or failed. Similarly, execution of a given mutant target state can produce a test result indicating that the mutant target state passed or failed.

At 850, the test results are aggregated to obtain a quantitative quality measure of the test code completion tool. As described further herein, benchmark metrics can be determined based on the test results, from which a quantitative quality measure of the test code completion tool can be derived.

At 860, the quantitative quality measure of the test code completion tool is output, e.g., in the manner described above with reference to step 370 of FIG. 3. Depending on the quantitative quality measure, the test code completion tool may be released to users (e.g., if the quantitative quality measure is above a predefined threshold), or release of the test code completion tool to users may be blocked (e.g., if the quantitative quality measure is below the predefined threshold).

### Example 12

### Example Implementations

Any of the following can be implemented.

Clause 1. A computer-implemented method comprising: receiving a set of software artifacts; receiving, for a given software artifact of the set of software artifacts, a plurality of mutated versions of the given software artifact; employing a test automate generation tool to generate a plurality of test automates, wherein a given test automate of the plurality of test automates is associated with the given software artifact and comprises code with references to the given software artifact; creating sets of mutant test automates, wherein a given one of the sets of mutant test automates is associated with the given test automate, and wherein a given mutant test automate of the given one of the sets of mutant test automates is created by modifying the given test automate to include references to a given one of the mutated versions of the given software artifact; executing the test automates and the mutant test automates to obtain respective test results; aggregating the test results to obtain a quantitative quality measure of the test automate generation tool; and outputting the quantitative quality measure of the test automate generation tool.

Clause 2. The method of Clause 1, wherein creating the given mutant test automate further comprises: creating a modified version of the code of the given test automate by replacing the references to the given software artifact with the references to the given one of the mutated versions of the given software artifact; and populating the given mutant test automate with the modified version of the code of the given test automate.

Clause 3. The method of Clause 1 or Clause 2, wherein the set of software artifacts comprises at least one of the following: a set of virtual data model objects; a set of Structured Query Language (SQL) views; a set of classes; or a set of scripts.

Clause 4. The method of any one of Clauses 1-3, wherein the mutated versions of the given software artifact are generated manually by a domain expert.

Clause 5. The method of any one of Clauses 1-4, wherein the given one of the mutated versions of the given software artifact comprises exactly one elementary mutation of the given software artifact.

Clause 6. The method of any one of Clauses 1-5, wherein respective ones of the mutated versions of the given software artifact comprise different mutations of the given software artifact, and wherein the mutations of the given software artifact comprise at least one of the following: a statement deletion; an operator replacement; a variable replacement; a constant replacement; or a condition negation.

Clause 7. The method of any one of Clauses 1-6, wherein the test result for a given one of the test automates and mutant test automates indicates that the given one of the test automates and mutant test automates passed or failed.

Clause 8. The method of Clause 7, wherein aggregating the test results to obtain the quantitative quality measure of the test automate generation tool comprises at least one of the following: determining a number of the test automates that passed; determining a number of the mutant test automates that passed; determining a number of the test automates that failed; determining a number of the mutant test automates that failed; determining a percentage of the test automates that passed; or determining a percentage of the mutant test automates that failed.

Clause 9. The method of Clause 8, wherein aggregating the test results to obtain the quantitative quality measure of the test automate generation tool further comprises: determining a sensitivity metric based on the number of mutant test automates that failed and a total number of the mutant test automates; and determining a specificity metric based on the number of test automates that passed and a total number of the test automates.

Clause 10. The method of any one of Clauses 1-9, wherein the test automate generation tool is a new version of a currently deployed test automate generation tool, the method further comprising: obtaining a quantitative quality measure of the currently deployed test automate generation tool; comparing the quantitative quality measure of the new version of the test automate generation tool to the quantitative quality measure of the currently deployed test automate generation tool; determining, based on the comparing, that the quantitative quality measure of the new version of the test automate generation tool is less than the quantitative quality measure of the currently deployed test automate generation tool; and outputting an indication of a quality regression of the new version of the test automate generation tool.

Clause 11. The method of Clause 10, further comprising: responsive the indication of quality regression of the new version of the test automate generation tool, blocking release of the new version of the test automate generation tool.

Clause 12. The method of any one of Clauses 1-11, wherein the test automate generation tool employs generative artificial intelligence to generate the test automates.

Clause 13. The method of any one of Clauses 1-12, wherein employing the test automate generation tool to generate the plurality of test automates comprises sending a request to an Application Programming Interface (API) of the test automate generation tool.

Clause 14. A computing system, comprising: at least one hardware processor; at least one memory coupled to the at least one hardware processor; a stored set of software artifacts; stored sets of mutated versions of the software artifacts; and one or more non-transitory computer-readable media having stored therein computer-executable instructions that, when executed by the computing system, cause the computing system to perform operations implementing a benchmark runner for a test automate generation tool, the operations comprising: receiving a plurality of test automates generated by the test automate generation tool, wherein a given test automate of the plurality of test automates is associated with a given software artifact of the stored set of software artifacts; creating sets of mutant test automates associated with respective test automates of the plurality of test automates, wherein a given one of the mutant test automates is created by modifying the given test automate to include references to a given one of the mutated versions of the given software artifact; executing the test automates and the mutant test automates to obtain respective test results; aggregating the test results to obtain benchmark metrics comprising a quantitative quality measure of the test automate generation tool; and outputting the benchmark metrics.

Clause 15. The system of Clause 14, wherein: the given test automate comprises code with references to the given software artifact, and creating the given one of the mutant test automates further comprises creating a modified version of the code of the given test automate in which references to the given software artifact are replaced with the references to create given one of the mutated versions of the given software artifact.

Clause 16. The system of Clause 14 or Clause 15, wherein the creating of the sets of mutant test automates is performed by a mutant test automate creator of the benchmark runner.

Clause 17. The system of Clause 16, wherein: the operations further comprise sending a request for test automates to the test automate generation tool, the request includes the software artifacts, and the plurality of test automates are received from the test automate generation tool in response to the request.

Clause 18. The system of Clause 16 or Clause 17, wherein: aggregating the test results to obtain the benchmark metrics comprises determining at least one of the following: a total number of the test automates; a total number of the mutant test automates; a number of the mutant test automates that failed; a number of test automates that passed; a sensitivity metric; a specificity metric; a balanced accuracy metric; a harmonic mean of sensitivity and specificity metric; a Matthews Correlation Coefficient metric; or an F₁ score metric.

Clause 19. One or more non-transitory computer-readable media comprising computer-executable instructions that, when executed by a computing system, cause the computing system to perform operations comprising: receiving a set of incomplete software artifacts, wherein a given incomplete software artifact of the set of incomplete software artifacts comprises incomplete productive code and incomplete test code; receiving a target state of the given incomplete software artifact, wherein the target state comprises complete productive code and a modified version of the incomplete test code, and wherein the modified version of the incomplete test code comprises a placeholder for insertion of predicted code; receiving a plurality of mutant target states of the given incomplete software artifact, wherein the respective mutant target states comprises the modified version of the incomplete test code and a mutated version of the complete productive code; employing a test code completion tool to generate the predicted code based on the given incomplete software artifact; replacing the placeholder in the modified version of the incomplete test code of the target state with the predicted code to generate complete test code of the target state; replacing the placeholders in the modified version of the incomplete test code of the respective mutant target states with the predicted code to generate complete test code of the mutant target states; executing the complete test code of the target state and the mutant target states to obtain respective test results; aggregating the test results to obtain a quantitative quality measure of the test code completion tool; and outputting the quantitative quality measure of the test code completion tool.

Clause 20. The computer-readable media of Clause 19, wherein the incomplete productive code of the given incomplete software artifact comprises an indication of a cursor position.

### Example 13

### Example Advantages

A number of advantages can be achieved via the technologies described herein. For example, in contrast to techniques in which mutations are automatically generated without expert guidance about mutation strategy, the disclosed technologies utilized mutated versions of software artifacts that were generated by domain experts. While there are one-time costs associated with obtaining the manually-generated mutant software artifacts, the remainder of the process for assessing the test automate generation tool can be performed programmatically (and thus, automatically, without human intervention). Accordingly, ongoing costs of assessing the test automate generation tool are minimized relative to prior techniques which require a human-in-the-loop to qualitatively assess the performance of the test automate generation tool.

Such technologies can improve the granularity of the assessment, which in turn allows for early detection of regression in the performance of the test automate generation tool (e.g., due to model drift). For example, by providing a quantitative assessment which is repeatable and efficient, the disclosed technologies allow for automated monitoring of test automate generation tool performance which is both cost-effective and more accurate than existing qualitative techniques.

### Example 14

### Example Computing Systems

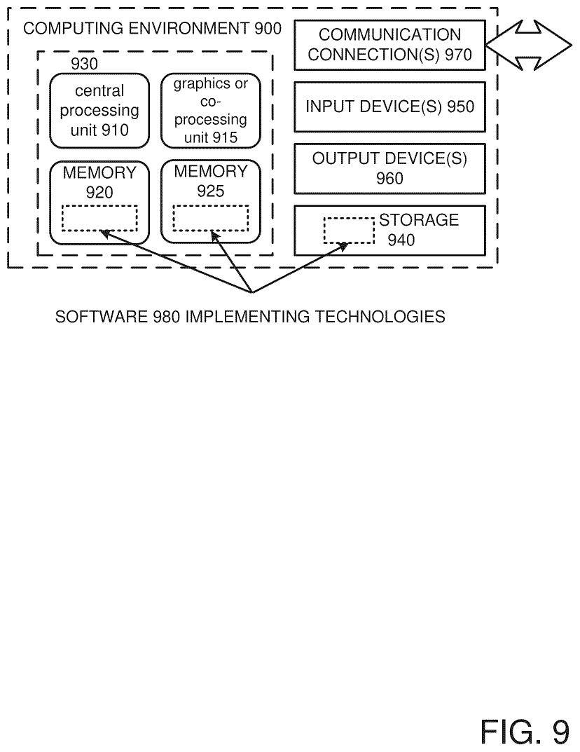

FIG. 9 depicts an example of a suitable computing system 900 in which the described innovations can be implemented. The computing system 900 is not intended to suggest any limitation as to scope of use or functionality of the present disclosure, as the innovations can be implemented in diverse computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 can be volatile memory (e.g., registers, cache, RAM), non-volatile memory (e.g., ROM, EEPROM, flash memory, etc.), or some combination of the two, accessible by the processing unit(s) 910, 915. The memory 920, 925 stores software 980 implementing one or more innovations described herein, in the form of computer-executable instructions suitable for execution by the processing unit(s) 910, 915.

A computing system 900 can have additional features. For example, the computing system 900 includes storage 940, one or more input devices 950, one or more output devices 960, and one or more communication connections 970, including input devices, output devices, and communication connections for interacting with a user. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 can be removable or non-removable, and includes magnetic disks, magnetic tapes or cassettes, CD-ROMs, DVDs, or any other medium which can be used to store information in a non-transitory way and which can be accessed within the computing system 900. The storage 940 stores instructions for the software 980 implementing one or more innovations described herein.

The input device(s) 950 can be an input device such as a keyboard, mouse, pen, or trackball, a voice input device, a scanning device, touch device (e.g., touchpad, display, or the like) or another device that provides input to the computing system 900. The output device(s) 960 can be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example 15

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example 16

### Example Cloud Computing Environment

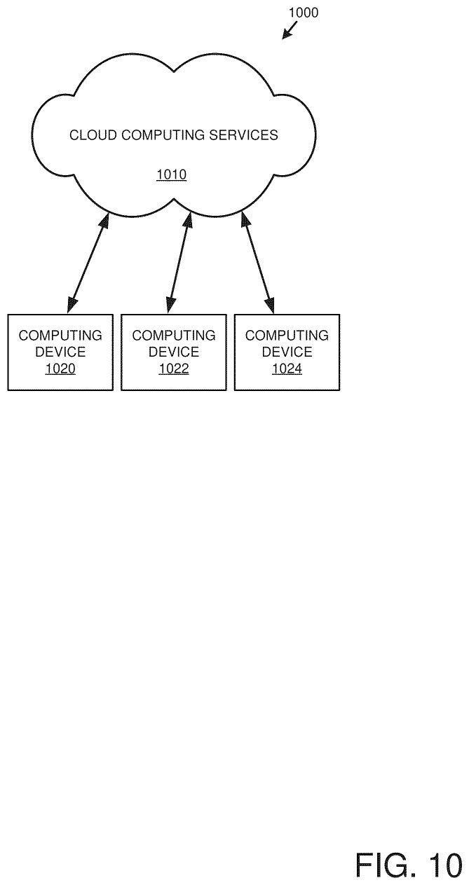

FIG. 10 depicts an example cloud computing environment 1000 in which the described technologies can be implemented, including, e.g., the system 100 of FIG. 1 and other systems herein. The cloud computing environment 1000 comprises cloud computing services 1010. The cloud computing services 1010 can comprise various types of cloud computing resources, such as computer servers, data storage repositories, networking resources, etc. The cloud computing services 1010 can be centrally located (e.g., provided by a data center of a business or organization) or distributed (e.g., provided by various computing resources located at different locations, such as different data centers and/or located in different cities or countries).

The cloud computing services 1010 are utilized by various types of computing devices (e.g., client computing devices), such as computing devices 1020, 1022, and 1024. For example, the computing devices (e.g., 1020, 1022, and 1024) can be computers (e.g., desktop or laptop computers), mobile devices (e.g., tablet computers or smart phones), or other types of computing devices. For example, the computing devices (e.g., 1020, 1022, and 1024) can utilize the cloud computing services 1010 to perform computing operations (e.g., data processing, data storage, and the like).

In practice, cloud-based, on-premises-based, or hybrid scenarios can be supported.

### Example 17

### Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 18

### Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving a set of software artifacts;
receiving, for a given software artifact of the set of software artifacts, a plurality of mutated versions of the given software artifact;
employing a test automate generation tool to generate a plurality of test automates, wherein a given test automate of the plurality of test automates is associated with the given software artifact and comprises code with references to the given software artifact;
creating sets of mutant test automates, wherein a given one of the sets of mutant test automates is associated with the given test automate, and wherein a given mutant test automate of the given one of the sets of mutant test automates is created by modifying the given test automate to include references to a given one of the mutated versions of the given software artifact;
executing the test automates and the mutant test automates to obtain respective test results;
aggregating the test results to obtain a quantitative quality measure of the test automate generation tool; and
outputting the quantitative quality measure of the test automate generation tool.

2. The method of claim 1, wherein creating the given mutant test automate further comprises:
creating a modified version of the code of the given test automate by replacing the references to the given software artifact with the references to the given one of the mutated versions of the given software artifact; and
populating the given mutant test automate with the modified version of the code of the given test automate.

3. The method of claim 1, wherein the set of software artifacts comprises at least one of the following:
a set of virtual data model objects;
a set of Structured Query Language (SQL) views;
a set of classes; or
a set of scripts.

4. The method of claim 1, wherein the mutated versions of the given software artifact are generated manually by a domain expert.

5. The method of claim 1, wherein the given one of the mutated versions of the given software artifact comprises exactly one elementary mutation of the given software artifact.

6. The method of claim 1, wherein respective ones of the mutated versions of the given software artifact comprise different mutations of the given software artifact, and wherein the mutations of the given software artifact comprise at least one of the following:
a statement deletion;
an operator replacement;
a variable replacement;
a constant replacement; or
a condition negation.

7. The method of claim 1, wherein the test result for a given one of the test automates and mutant test automates indicates that the given one of the test automates and mutant test automates passed or failed.

8. The method of claim 7, wherein aggregating the test results to obtain the quantitative quality measure of the test automate generation tool comprises at least one of the following:
determining a number of the test automates that passed;
determining a number of the mutant test automates that passed;
determining a number of the test automates that failed;
determining a number of the mutant test automates that failed;
determining a percentage of the test automates that passed; or
determining a percentage of the mutant test automates that failed.

9. The method of claim 8, wherein aggregating the test results to obtain the quantitative quality measure of the test automate generation tool further comprises:
determining a sensitivity metric based on the number of mutant test automates that failed and a total number of the mutant test automates; and
determining a specificity metric based on the number of test automates that passed and a total number of the test automates.

10. The method of claim 1, wherein the test automate generation tool is a new version of a currently deployed test automate generation tool, the method further comprising:
obtaining a quantitative quality measure of the currently deployed test automate generation tool;
comparing the quantitative quality measure of the new version of the test automate generation tool to the quantitative quality measure of the currently deployed test automate generation tool;
determining, based on the comparing, that the quantitative quality measure of the new version of the test automate generation tool is less than the quantitative quality measure of the currently deployed test automate generation tool; and
outputting an indication of a quality regression of the new version of the test automate generation tool.

11. The method of claim 10, further comprising:
responsive the indication of quality regression of the new version of the test automate generation tool, blocking release of the new version of the test automate generation tool.

12. The method of claim 1, wherein the test automate generation tool employs generative artificial intelligence to generate the test automates.

13. The method of claim 1, wherein employing the test automate generation tool to generate the plurality of test automates comprises sending a request to an Application Programming Interface (API) of the test automate generation tool.

14. A computing system, comprising:
at least one hardware processor;
at least one memory coupled to the at least one hardware processor;
a stored set of software artifacts;
stored sets of mutated versions of the software artifacts; and
one or more non-transitory computer-readable media having stored therein computer-executable instructions that, when executed by the computing system, cause the computing system to perform operations implementing a benchmark runner for a test automate generation tool, the operations comprising:
receiving a plurality of test automates generated by the test automate generation tool, wherein a given test automate of the plurality of test automates is associated with a given software artifact of the stored set of software artifacts;
creating sets of mutant test automates associated with respective test automates of the plurality of test automates, wherein a given one of the mutant test automates is created by modifying the given test automate to include references to a given one of the mutated versions of the given software artifact;
executing the test automates and the mutant test automates to obtain respective test results;
aggregating the test results to obtain benchmark metrics comprising a quantitative quality measure of the test automate generation tool; and
outputting the benchmark metrics.

15. The system of claim 14, wherein:
the given test automate comprises code with references to the given software artifact, and
creating the given one of the mutant test automates further comprises creating a modified version of the code of the given test automate in which references to the given software artifact are replaced with the references to create given one of the mutated versions of the given software artifact.

16. The system of claim 14, wherein the creating of the sets of mutant test automates is performed by a mutant test automate creator of the benchmark runner.

17. The system of claim 16, wherein:
the operations further comprise sending a request for test automates to the test automate generation tool,
the request includes the software artifacts, and
the plurality of test automates are received from the test automate generation tool in response to the request.

18. The system of claim 16, wherein:
aggregating the test results to obtain the benchmark metrics comprises determining at least one of the following:
a total number of the test automates;
a total number of the mutant test automates;
a number of the mutant test automates that failed;
a number of test automates that passed;
a sensitivity metric;
a specificity metric;
a balanced accuracy metric;
a harmonic mean of sensitivity and specificity metric;
a Matthews Correlation Coefficient metric; or
an F₁ score metric.

19. One or more non-transitory computer-readable media comprising computer-executable instructions that, when executed by a computing system, cause the computing system to perform operations comprising:
receiving a set of incomplete software artifacts, wherein a given incomplete software artifact of the set of incomplete software artifacts comprises incomplete productive code and incomplete test code;
receiving a target state of the given incomplete software artifact, wherein the target state comprises complete productive code and a modified version of the incomplete test code, and wherein the modified version of the incomplete test code comprises a placeholder for insertion of predicted code;
receiving a plurality of mutant target states of the given incomplete software artifact, wherein the respective mutant target states comprises the modified version of the incomplete test code and a mutated version of the complete productive code;
employing a test code completion tool to generate the predicted code based on the given incomplete software artifact;
replacing the placeholder in the modified version of the incomplete test code of the target state with the predicted code to generate complete test code of the target state;
replacing the placeholders in the modified version of the incomplete test code of the respective mutant target states with the predicted code to generate complete test code of the mutant target states;
executing the complete test code of the target state and the mutant target states to obtain respective test results;
aggregating the test results to obtain a quantitative quality measure of the test code completion tool; and
outputting the quantitative quality measure of the test code completion tool.

20. The computer-readable media of claim 19, wherein the incomplete productive code of the given incomplete software artifact comprises an indication of a cursor position.
